(19) United States
(12) Patent Application Publication
(10) Pub. No.: US 2009/0241960 A1
(43) Pub. Date: Oct. 1, 2009

(54) DUAL HIGH AND LOW PRESSURE BREATHING SYSTEM

(75) Inventors: Stephen Tunnell, Oceanside, CA (US); Patrick Nguyen, Carlsbad, CA (US); Kosuke Inoue, Corona Del Mar, CA (US)

Correspondence Address: KNOBBE MARTENS OLSON & BEAR LLP, 2040 MAIN STREET, FOURTEENTH FLOOR, IRVINE, CA, 92614, US

(73) Assignee: eVent Medical, Inc., Aliso Viejo, CA (US)

(21) Appl. No.: 12/060,584

(22) Filed: Apr. 1, 2008

(51) Int. Cl. A62B 9/02

(52) U.S. Cl. 128/205.24

(57) ABSTRACT

A breathing system allows a single valve and corresponding control system to utilize either high or low pressure gas input and control the delivery of gas to a patient in a manner independent of the gas pressure level. Some such systems include a blower that provides gas with low pressure, a high pressure inlet port, a force balance valve or similar that will regulate the high pressure to work in the low pressure system, and a proportional valve assembly with a unitary control system that will allow for efficient ventilation operations regardless of gas source. Some such systems are capable of seamless transition from low to high pressure and from high to low pressure gas sources, as well as independent operation while either source serves as an input.

### FIELD OF THE INVENTION

The invention is generally directed to a ventilator control system incorporating a dual high and low pressure valve assembly allowing for compact and efficient operation. Embodiments of the invention may be used as, by way of non-limiting example, a medical ventilator, or breathing apparatus.

### BACKGROUND

Ventilators and other respiratory support devices may be used to either ventilate patients who have breathing difficulties or an inability to breath on their own or to remove respiratory work in the presence of organ failure (i.e., heart or lung). A medical ventilator is an automatic machine designed to mechanically move breathable gas into and out of the lungs, to provide respiration for a patient who is physically unable to breathe, or who is breathing insufficiently. Ventilators may also be used as gas mixing devices to condition the delivery and the gas mixture inhaled by a patient. Certain ventilators are designed to create appropriate gas mixtures to deliver into the patient's breathing circuit, airways, and lungs.

As depicted in FIG. 1, traditional breathing devices, such as a ventilator (100) may use a low pressure system, which may include, for example, a blower (102). Mechanical ventilators may also use a high pressure system, which may include, for example, a wall air or oxygen pressure connection through a check valve (114) incorporating a high pressure sensor (112) that serves to detect air or oxygen high pressure for a system sending gas flow through a mechanical pressure regulator (110). The high pressure system and the low pressure system both require a proportional corresponding valve and control system (104, 108) to regulate gas to the patient (106). The high pressure and low pressure system each require a separate valve and separate control system to regulate their respective valves.

### SUMMARY OF SELECT EMBODIMENTS OF THE INVENTION

In view of the limitations now present in the prior art, the present invention provides a new and useful way to integrate a high and low pressure source with a single breathing control system. Some embodiments allow a single valve and control system to utilize either high or low pressure gas input and control the delivery of gas to a patient in a manner independent of the input gas pressure level. Thus, problems resulting from inconsistent pressure of the input can now be mitigated to provide continuous breathing support to the patient regardless of the environment in which their care for is provided. Historically, low pressure input systems (e.g., blowers, concentrators, liquid gas) were used for lower levels of support and facilitated transport care in non-traditional hospital environments (e.g., skilled nursing centers, home, ambulance) while high pressure gas sources were more commonly found in traditional hospital-like environments. Some embodiments of the invention allow breathing support with a single control system regardless of local conditions. Such a system may allow for seamless transition of a ventilator from a low pressure flow environment to a high pressure flow source. Some embodiments of the invention reduce the constructional size of a ventilator through a dual control valve system for high and low pressure manipulation.

In some embodiments, a high pressure path may connect directly to a low pressure system. A pressure balance valve may then be deployed to allow low pressure gas to flow, or alternatively allow for switching to high pressure, by regulating the orifice of the pressure balance valve. In an exemplary embodiment, the pressure balance valve may have a large opening at a normal flow condition. Such a configuration may operate in conjunction with the blower base. At a determined trigger point, the high pressure system may activate the mechanism of the pressure balance valve to close the large opening while maintaining the pressure at, e.g., 2.5 psi. Such an example configuration allows the system to work concurrently with a low pressure valve. For example, in one dual high and low pressure configuration, the high pressure path may be the master. A high pressure sensor may then be used to monitor pressure and/or flow rate to determine when a set threshold variable is reached that may automatically trigger the system to switch to a blower, or similar low pressure flow source. Some embodiments allow the user to utilize the same control system for a high and low pressure inlet, or any combination of the two.

In one embodiment, this invention provides a breathing apparatus comprising a low pressure gas source configured to deliver gas into a low pressure chamber; a high pressure gas inlet port connected to a force balance valve configured to deliver high pressure gas into the low pressure chamber after pressure reduction through the force balanced valve; a proportional valve assembly for receiving flow from both the high pressure gas inlet port and from the low pressure gas source; a control system that operates the proportional valve assembly; and an outlet port downstream of the proportional valve assembly.

In a preferred mode, the low pressure source is selected from the set consisting of: a blower, liquid gas, a compressor, a concentrator system and a piston. Alternatively, the breathing apparatus may further comprise a pressure detector configured to sense an absence of the high pressure gas, where upon the control system automatically engages the low pressure gas source in response to the pressure detector detecting the absence of the high pressure gas.

In another embodiment, this invention provides a breathing apparatus comprising a low pressure gas inlet port configured to receive gas from a low pressure gas source; a high pressure gas inlet port configured to receive gas from a high pressure gas source; various devices that reduce gas pressure downstream of the high pressure gas inlet port; a low pressure path configured to receive gas from both the devices that reduce gas pressure and from the low pressure inlet port; and a proportional low pressure valve coupled to the low pressure path and configured to control flow delivery to a patient.

Preferably, this breathing apparatus further comprises an integrated control system capable of controlling the proportional low pressure valve and the activation of the low pressure gas source. More preferably, the integrated control system controls and directs gas flow from at least one of the low pressure gas source and the high pressure gas source.

This invention also provides a method of providing breathable gas to a patient that involves initiating high pressure gas flow from a high pressure gas source through a high pressure gas inlet port, as well as reducing a pressure of the high pressure gas between the high pressure gas inlet port and a low pressure chamber or flow path. The method also allows controlling a flow of the reduced high pressure gas from the low pressure chamber through a low pressure proportional control valve, and detecting a reduction of pressure in the high pressure source. In some configurations, the system may activate, in response to the detecting, a low pressure gas flow from a low pressure gas source through a low pressure gas inlet port. Further, the method may provide the low pressure gas flow from the gas inlet port into the low pressure chamber, and control the gas flow of the low pressure gas flow from the low pressure chamber through the low pressure proportional control valve, and this with an intended result of providing gas flow to a patient downstream of the low pressure proportional control valve.

This method may be used to ensure that gas flow is continuously provided to the patient. In a preferred mode, the step of providing the low pressure flow from the gas inlet port occurs for a set period of time, or it may occur in intervals of time. A further preferred mode entails re-initiating the high pressure gas flow from the high pressure gas source after the set period of time has ended.

In another embodiment, this invention provides a method of providing breathable gas to a patient that entails receiving data inputs related to the control of a breathing device, and transferring data inputs into a control system. During operation, the method may enable the input of either a reduced high pressure gas flow path or a low pressure gas flow path into a low pressure valve based upon the data inputs to the control system. Likewise, at any time the method may engage the control system to control flow of either the reduced high pressure gas flow path or the low pressure gas flow path through the low pressure valve. Similarly, the method may at any point detect a presence or an absence of a high pressure gas source, and create a second set of data inputs based upon the presence or the absence of the high pressure gas source; and thereafter transfer the second set of data inputs to the control system.

### BRIEF DESCRIPTION OF THE DRAWINGS

FIG. 1 depicts a traditional high/low pressure gas delivery system of the prior art.

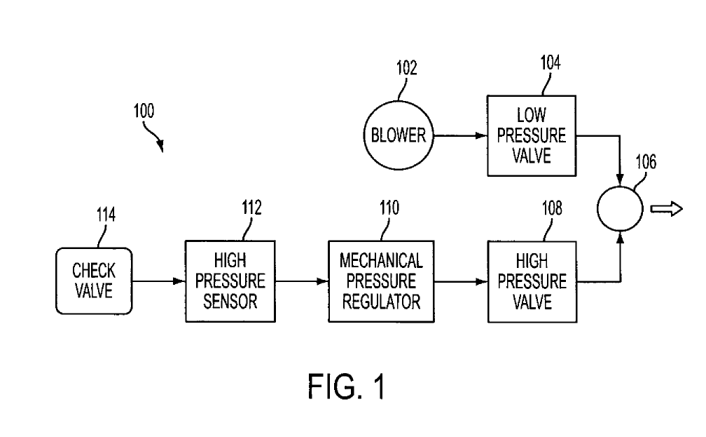

FIG. 2 depicts pressure system according to an embodiment of the present invention.

FIG. 3 depicts a block flow diagram of an example control system according to an embodiment of the present invention.

FIG. 4 depicts an example dual valve assembly according to an embodiment of the present invention.

FIG. 5 depicts an example control system with single valve assembly according to an embodiment of the present invention.

FIG. 6 depicts a dual path system incorporating oxygen and air according to an embodiment of the present invention.

### DETAILED DESCRIPTION OF SOME EMBODIMENTS

In one embodiment, a breathing apparatus of this invention may be equipped with monitoring and alarm systems for patient-related parameters (e.g., pressure, volume, and flow) and ventilator function (e.g. gas leakage, power failure, mechanical failure), backup batteries, oxygen tanks, and remote control operation and/or monitoring. The ventilator may operate with a low pressure gas source such as a blower or compressor that operates on either battery power or a wall outlet source for A/C current. In certain configurations, the ventilator may be docked into a station that may provide improved user interface controls and monitoring. Other embodiments of the invention contemplate a transportable, stand alone, ventilation system, which may also include a portable high pressure gas or oxygen source. Further, an embodiment of the present invention includes a ventilator that may be electronically controlled by a small embedded system to allow exact adaptation of pressure and flow characteristics to an individual patient's needs, including sigh ventilation control. One such control system is described further in U.S. Pat. No. 7,219,666, to Friberg et al, the disclosure of which is incorporated by reference herein in its entirety. Finely controlled ventilator settings serve to make ventilation more tolerable and comfortable for the patient.

Some embodiments of the present invention provide a control system for the use of a high pressure gas source with a low pressure valve. The same control system and proportional valve may be incorporated to control gas flow from either a high pressure or low pressure supply. Other embodiments include a force balanced valve to control and regulate the high pressure inlet and in some configurations the low pressure inlet. The system may also use a single control system for a dual seat (high and low pressure) proportional control valve.

Various sensors and control systems may be incorporated to achieve the control of the single integrated system that allows a single valve to utilize either high or low pressure gas input and thereafter control the delivery of gas to the patient in a manner independent of the source gas pressure level. A gateway path may also combine the regulator function for high pressure flow reduction into a single valve assembly in order to eliminate components. The control system may be capable of metering high pressure flow through a pathway and single dual proportional valve assembly by choking down a pathway. For example, at a select gate the control system may recognize high pressure and may thereafter send flow down a select path to reduce pressure.

Although a feedback controller may be used, an open-loop controller may be incorporated in certain embodiments with stable predicted outputs in the alternative. An open-loop control system may operate by causing a single dual seat proportional valve to allow flow from either a high or low pressure source, where the valve may open or close as needed to deliver a set volume of gas to a patient. In some open loop embodiments, with known parameters such as flow rate, no feedback to the control system determining actual flow conditions is required. Control of the dual seat proportional valve may be predetermined by the controller to allow a stable and predicted flow to the patient. In any embodiment the control system may comprise a microcomputer embedded or external.

In one embodiment, an integrated feedback control system may rely on an internal or external computer(s) for the controller. The feedback controller may be one of several types, such as a proportional controller. With this type of controller, the controller output (control action) is proportional to the error in the measured variable. A proposed system may consist of an integrated dual valve system that is capable of allowing high pressure and low pressure inlets to both operate using a low pressure valve and its control system. In such an embodiment, a single control system for the low pressure valve may replace a dual control system. The integrated valve system may also compose a manifold assembly with three ports: a high pressure inlet, a low pressure inlet (e.g., from a blower, compressor or similar) and a port flow outlet to a patient. The low pressure gas devices may be a blower in some embodiments, but it may alternately be a piston assembly to generate low flow, a compressor—e.g., a small portable compressor—or a concentrator system—e.g., O₂ concentrator for low flow O₂ delivery. In one embodiment, the high pressure port may be gated by a force balanced valve. The force balanced valve may regulate flow into a low pressure chamber, and the valve may be capable of maintaining pressure within a certain operating range—for example, to be within 2.0 psi (or 140 cm H₂O).

In other embodiments, alternates to proportional control may be used for the integrated single control system, such as a proportional-integral (PI) control or a proportional-integral-derivative (PID) to implement closed-loop control. A proportional-integral-derivative controller (PID controller) may operate based upon desired output conditions or parameters related to one or more of: flow, pressure, temperature, volume, or gas mixture, and then attempt to correct the error between one or more measured process variables and the desired output by calculating and then outputting a corrective action that can adjust the process accordingly. The PI or PID controller calculation may incorporate various algorithms which analyze separate parameters values related to ventilation output. A programmable filter may consider the error of the system compared to the desired output in order to adjust the process via one or more control elements in the dual pressure control valve, such as whether to allow flow from the high pressure supply, or flow from the low pressure supply, while blocking flow from the undesired source. The programmable filter may be used in conjunction with the control assembly and may further be located in a feedforward or feedback path of the system. Other such control operations may entail automatic switching from low pressure operation, with for example a blower, to high pressure operations when a triggering event is met, such as detection of a high pressure source.

Another object of the present invention is to provide a force balanced valve to regulate the low and/or high pressure inlet for the valve. Such a valve may incorporate a dual high and low pressure inlet. In other embodiments the force balance valve provides pressure reduction for the high pressure flow path. In some embodiments, an integrated valve system may allow high and low pressure inlets to operate using a low pressure valve and its control system.

In another exemplary embodiment, the system may comprise three ports: a high pressure inlet, a low pressure inlet from a blower for example, and a port outlet to a patient. The high pressure inlet port may be gated by a force balanced valve. This force balanced valve may regulate flow into a low pressure chamber and maintain the pressure within a set pressure range, for example at approximately 2.0 psi (or 140 cm H₂O). The force balanced valve may be regulated, for example by controlling the valve with a PI controller and using a pressure tab, located within the low pressure chamber or the forced balanced valve, as a feedback device. A pressure sensor may also be located upstream of the force balanced valve. The low pressure inlet port may allow gas to be input from a blower at a determined pressure range, such as at about 2.0 psi. The input from the low pressure inlet would also flow into the low pressure chamber. Because pressure from the high pressure inlet and the low pressure inlet both converge in the same low pressure chamber at about 2.0 psi, a single proportional valve may be able to utilize a single PI controller to manage flow as well as pressure of the system. The outlet port to the patient is regulated and controlled by the single proportional valve. In certain other embodiments, the outlet port to the patient may also be regulated and controlled by a different valve such as a modified proportional valve, a voice coil valve, or an on/off valve.

In one embodiment the system may be based upon the high pressure inlet as a master and the low pressure inlet (blower) may be slaved to the system. In such an embodiment, a high pressure inlet sensor may be monitored to determine if there is a high pressure flow present. In the absence of a predetermined threshold of high pressure, the blower may be started to provide a gas source for flow into the low pressure chamber. Similarly, the presence of a high pressure source at the high pressure inlet may thereafter cause the low pressure inlet (blower) to shut down and the high pressure inlet will become the source for flow into the low pressure chamber, or low pressure flow path. In other embodiments, the low pressure inlet (blower) may be the master with the high pressure inlet slaved to the system. These embodiments all contemplate operation of the lower pressure inlet source in set time intervals as well.

Further aspects of the invention will become apparent from consideration of the drawings and the ensuing description of certain embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

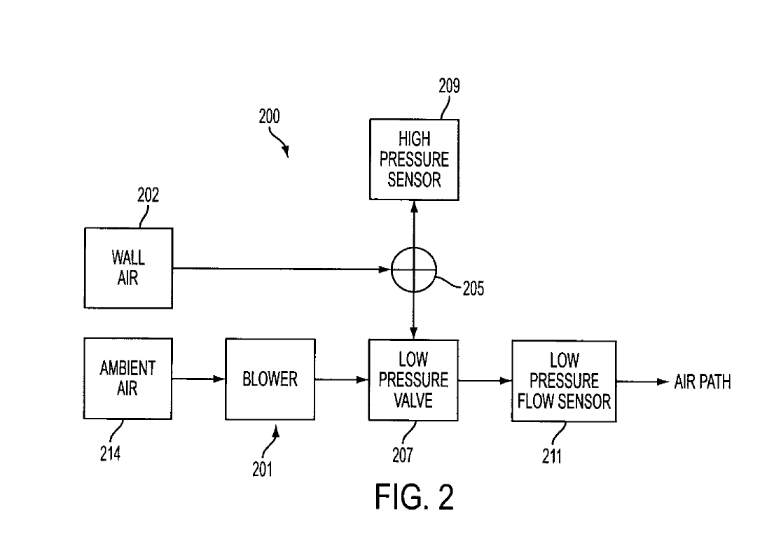

As shown in the example configuration of FIG. 2, a dual valve system (200) with both a blower (201) and a high pressure gas source (202) (e.g., a wall outlet operating between 30-90 psig may be configured such that the output of each is routed into a dual seat proportional valve (207). In the depicted embodiment, the blower (201) may operate using ambient air (214) with the blower (201) as a low pressure source at around 1.5-2.3 psig. A pressure reduction and manifold assembly (205) may be configured such that gas flow is allowed from a high pressure (202) supply with a high pressure sensor (209) connected. Flow may then be routed into a low pressure chamber within the manifold assembly (205). In some configurations, flow from either the high (202) or low (201) pressure source may occur while flow from the other source is blocked. Such a configuration allows for use of the low pressure (201) system while preventing, or blocking, high pressure (202) gas from being exhausted out of the dual seat proportional valve (207) into the low pressure system. A high pressure sensor (209) may help control such operation by detecting relevant parameters, such as pressure and flow, and sending electrical signals to a control system that in turn directs flow and valve (207) control allowing for operation of either a high or low pressure system. The dual seat proportional valve (207) may further be capable of accommodating both low and high pressure pathways as part of the valve assembly. The dual seat proportional valve (207) could also serve as a regulator for a high pressure reduction through automatic mechanical drop downs or channel restrictions that allow for pressure reduction. In either high or low pressure flow configuration, a downstream low pressure flow sensor (211) may be present for further flow regulation and control. Accordingly, a single control system may operate to control both high and low pressure flow configurations.

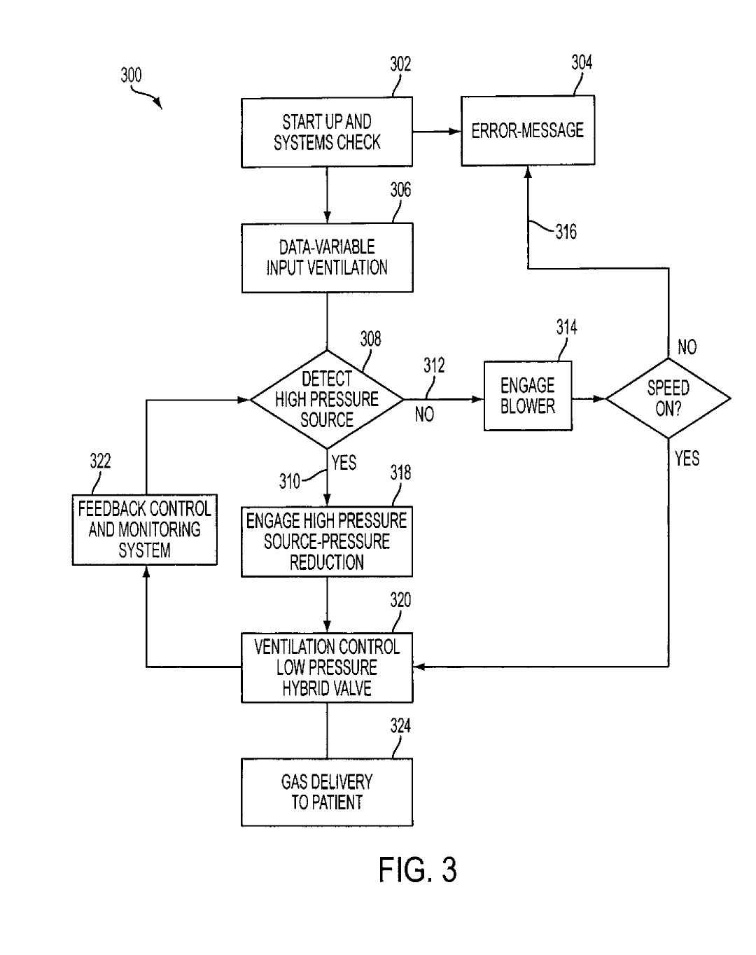

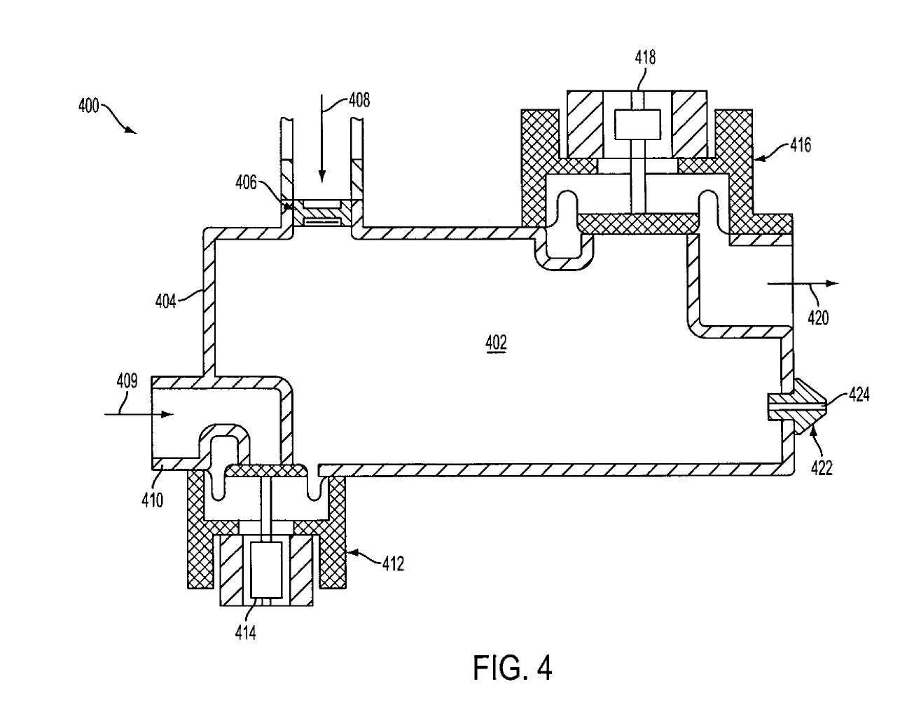

As depicted in FIG. 3, a sample logic flow diagram demonstrates how the system may operate. Control logic diagram (300) provides one example of typical operation for a ventilation system incorporating the novel control system and valve operation. At start up and systems check (302) the ventilator control system, including for example a central processing unit or hard drive, may perform an initiation sequence. During this sequence, individual systems and sensors, for example pressure tabs, may be tested for proper operation and function. If any system is determined inoperative or faulty, an output error signal may be generated and sent to error-message (304), which may also provide a detailed display or output of the specific fault or error of the system or sensor, viewable or audible to an operator. When start up and systems check (302) is complete a prompt for data or variable input (306) may occur in some embodiments. Such an input mechanism may allow for ventilation programming and control for specific patient parameters and needs. The data input block (306) may be excluded in many exemplary modes of operation. At detect high pressure source (308) the system may determine the presence of a suitable high pressure source, such as a wall outlet, or high pressure oxygen bottle. Various pressure gauges or similar sensors may be used as the detection mechanism for the high pressure source, and such sensors may be deployed at various locations depending upon system requirements. One of skill in the art would understand the numerous suitable high or low pressure detection devices that may be employed in this capacity. At detect high pressure source (308), the presence of a high pressure source will result in a signal (310) being generated that results in the engagement of high pressure source and pressure reduction (318) mechanism. When block (318) is engaged, the ventilation system will operate using a high pressure source for the ventilation air or gas. Pressure reduction of the high pressure source may occur in block (318) through mechanical reduction. For example, FIG. 4 provides an example of a high pressure reduction valve that may drop pressure to a degree suitable for use and control by a low pressure valve assembly. A regulator system, or a series of mechanical step downs that result in pressure reduction may also be employed at block (318) to reduce the ambient pressure to a degree suitable for the operation of ventilation control through the low pressure valve (320). At detect high pressure source (308), the absence of a high pressure source will result in a signal (312) being generated that results in the engagement of low pressure source (blower) (314). When engagement of blower (314) occurs a signal and message (316) may also be sent to error-message (304) that details the absence of a suitable high pressure source of operation, and/or that the blower has not been properly engaged at (314). The signal and message (316) may also detail operating conditions of the blower, including: power source, battery life, and usage information.

Both logic control operations of engage blower (314) and engage high pressure source-pressure reduction (318) may be controlled at ventilation control low pressure valve (320). Flow paths from engage high pressure (318) and engage low pressure (314) will transit into ventilation control low pressure valve (320) which may use a low pressure valve and control system to regulate gas delivery to patient (324). As part of the control system of block (320) a feedback control and monitoring system (322) may also operate to effect system operation and ventilation control. If during operation, at feedback control and monitoring system (322) a high pressure source is removed, the system may operate at detect high pressure source (308) with a negative signal (312) that will result in an automatic, or controlled, engagement of blower (314). Likewise, if feedback control and monitoring system (322) determines that the blower or low pressure source is compromised, the system may automatically seek out an available high pressure source at detect high pressure source (308).

It may also be desirable to engage ventilation control (320) and feedback control and monitoring system (322) in a manner that would allow operation of high pressure source (318) for specified period or time, or until a specified variable is met, and then engage blower (314) for a specified period of time or until a specified variable is met. Such control of the ventilation system may allow operation of the blower for a set period of time per day in order to maximize blower life, or in order to provide some variable influx of patient ventilation.

FIG. 4 provides one example of a proportional valve assembly. The dual seat proportional valve and manifold assembly (400) may comprise a low pressure chamber (402) surrounded by a manifold casing (404). The dual seat proportional valve and manifold assembly (400) may be made up of three ports: a high pressure inlet (409), a low pressure inlet (408) (e.g., from a blower) and an outlet port (420) flowing to a patient. The low pressure inlet (408) receives flow from a low pressure source, such as a blower, and may direct the flow through a check valve (406) into a low pressure chamber (402). A high pressure inlet (409) may receive air or oxygen from a high pressure source such as a wall outlet or tank. The high pressure inlet (409) may be configured to receive flow at an inlet port (410) as part of the manifold casing (404). In some configurations, inlet port (410) may be configured to provide pressure reductions through mechanical step-downs. The flow from high pressure inlet (409) may be transferred into a high pressure force balanced valve (412) comprised of a flow control system (414) that may be controlled by a PI controller that operates based upon sensor readings or input controls. Flow may occur through the high pressure force balanced valve (412) into low pressure chamber (402). The flow control system (414) may incorporate one or more check valves as well as sensors. The low pressure chamber (402) may provide flow into a proportional valve assembly (416) controlled through a proportional valve control assembly (418). The proportional valve control assembly (418) is capable of using a controller, such as a PI controller, to control the flow and the pressure of the system. Control may occur through sensor measurements taken at various points. For example, pressure tab (422) mounted into manifold casing (404) may have a pressure sensor (424) that provides determinations of physical attributes such as pressure and gas mixtures that will serve as inputs for the proportional valve control assembly (418), as well as for determining whether or not the low pressure source flow should be engaged through low pressure inlet (408). The proportional valve control assembly (418) may also operate to control flow for sigh ventilation for a patient. Flow through the proportional valve (416) is delivered through the outlet port (420) for delivery to a patient. A patient may be a natural person, or a mammal.

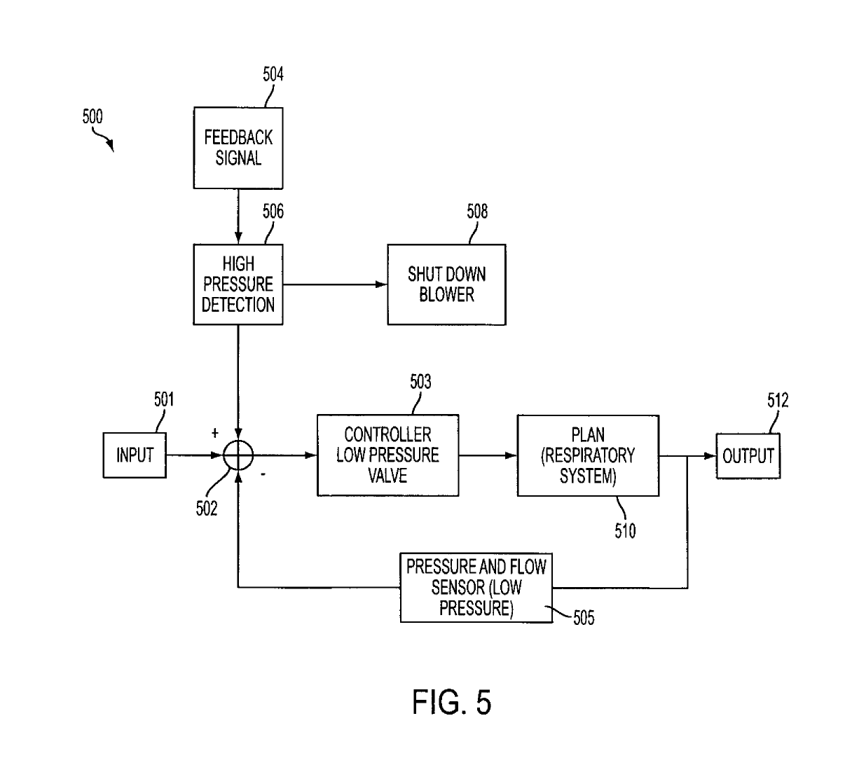

FIG. 5 illustrates an example of the ventilator dual pressure system (500) transitioning from a low pressure flow to a high pressure flow through a single dual seat proportional valve control assembly (502). At pressure and flow sensor (505) a feedback signal (504) may be determined. The feedback signal (504) may be input into a high pressure detection block (506) that serves to determine the presence or absence of a suitable high pressure gas source at an input (501). When, for example, a suitable high pressure gas source is detected at input (501) flowing into dual seat proportional valve control assembly (502), a control signal may be sent to the low pressure source, e.g., a blower, at block (508) directing shut down of the blower. Thereafter, a transition at input (501) from blower ventilation to high pressure gas source ventilation may occur through the low pressure valve control assembly (502) capable of receiving dual flow and converting it to a usable downstream low pressure gas flow through manipulation by a unitary controller (503). Controller (503) may operate through proportional-integral (PI) logic to control the dual seat proportional valve (502) and also to control other operations, for example shut down blower (508). Downstream ventilator operations and control may incorporate a plan for the respiratory system (510) allowing for specialized patient care and ventilation through an output (512). The plan for respiratory system (508) may take into account outside disturbances such as leak, humidity, or blockage, in devising an acceptable control systems solution. A feedback signal (504) may be generated through incorporation of a pressure and flow sensor (505) designed to continuously monitor pressure and flow at one or more strategic points. The data derived from pressure and flow sensor (505) may be used for valve control (502) as an input for controller (503), as well as for flow rate adjustments.

The ventilation system of FIG. 5 may accordingly allow for the extension of effective motor life for a blower, for example, that serves as a low pressure gas source, whereas the shutting down of the blower (508) may occur automatically according to control system parameters and appropriate patient monitoring conditions. The system may likewise establish conditions for the automatic introduction of low pressure source, or blower, flow when a high pressure gas source is removed from the circuit at input (501) or becomes impeded. At such a transition point, the controller (503) may serve to effectuate low pressure flow through the dual seat proportional valve assembly (502).

Other applications and uses for certain embodiments may be found in varied breathing apparatuses. The dual valve and control assembly may be integrated in several breathing devices including in a Constant Positive Airway Pressure (CPAP), or to a Bi-level (dual pressure level) Positive Airway Pressure (BiPAP) device or similar breathing systems. Devices supplying CPAP may be used for various effects including the treatment of sleep apnea by delivering a stream of air to a nasal pillow, nose mask or full-face mask, splinting the airway (keeping it open under air pressure) so that unobstructed breathing becomes possible, reducing and/or preventing apneas and hypopneas. Traditionally, a CPAP device consists of a blower and pressure transducer. The blower is the main source for producing air for the device. One embodiment of the proposed invention allows for an incorporation of a dual valve and control assembly that will enable the CPAP to use wall gas as well as a blower. Such an embodiment may therefore allow the same CPAP breathing device to be used in the hospital or as a portable CPAP. The implementation of an embodiment with a CPAP device can be done in several ways keeping within the spirit of the invention. In one embodiment, a CPAP device with a dual proportional valve will be operated using the blower as the source of gas. The dual proportional valve may serve to control delivery of gas to the patient and it may further be operated through a control system. Other embodiments may allow for predetermined flow without the need for active or feedback control. An analog or digital knob may be introduced to the system that allows the device to turn off the blower and activate a high pressure gas source. Thereafter, a high pressure flow may occur into an active force balanced valve—or other mechanical or electro/mechanical mode of pressure step down. Flow through the pressure reduction force balanced valve allows flow control to the patient through the dual proportional valve. After activation through the analog or digital control, the unit may begin to ventilate or provide similar flow to a patient.

Other embodiments may allow for mobile use of a portable ventilator or a mobile home oxygen delivery breathing device. Traditionally, patients with Chronic Obstructive Pulmonary Disease (COPD), also known as chronic obstructive airway diseases (COAD), will use a ventilator or similar breathing apparatus to provide oxygen therapy in a home environment. This is accomplished by using a high pressure tank, a pressure regulator to control the high pressure of oxygen delivered from a cylinder to a low pressure controllable by a flowmeter, and a disposable mask, for example. One embodiment of the invention allows the oxygen patient to use a portable breathing device with an oxygen tank to have a more controllable ventilation through use of the proportional valve and control assembly.

Still in other embodiments of the invention, a high pressure gas source, such as a tank or high pressure line, may be used by delivering gas flow through a force balanced valve and into a low pressure reservoir or flow path. Thereafter, flow may occur through a low pressure proportional valve that will control flow and delivery of gas to an individual. In the same closed system, a liquid oxygen (or similar gas blend) dispensing apparatus may also be integrated as a low pressure source. At some predetermined triggering event, such as the removal of the high pressure source, the low pressure liquid oxygen source may be active and flow may occur into a low pressure reservoir or flow path. Selection of low or high pressure flow source may also be made by a user of the system. Thereafter, flow may occur through the low pressure proportional valve from the low pressure source. The proportional valve and control system may serve to control delivery rate and pressure as well as triggering of one flow path over another. Such an embodiment may find uses in underwater breathing devices, or even within space breathing apparatuses. In such environments, a primary high pressure source, such as a gas tank, could be backed up by a low pressure source, such as a liquid oxygen supply, but with space being saved through the use of a single flow path and dual proportional low pressure control valve.

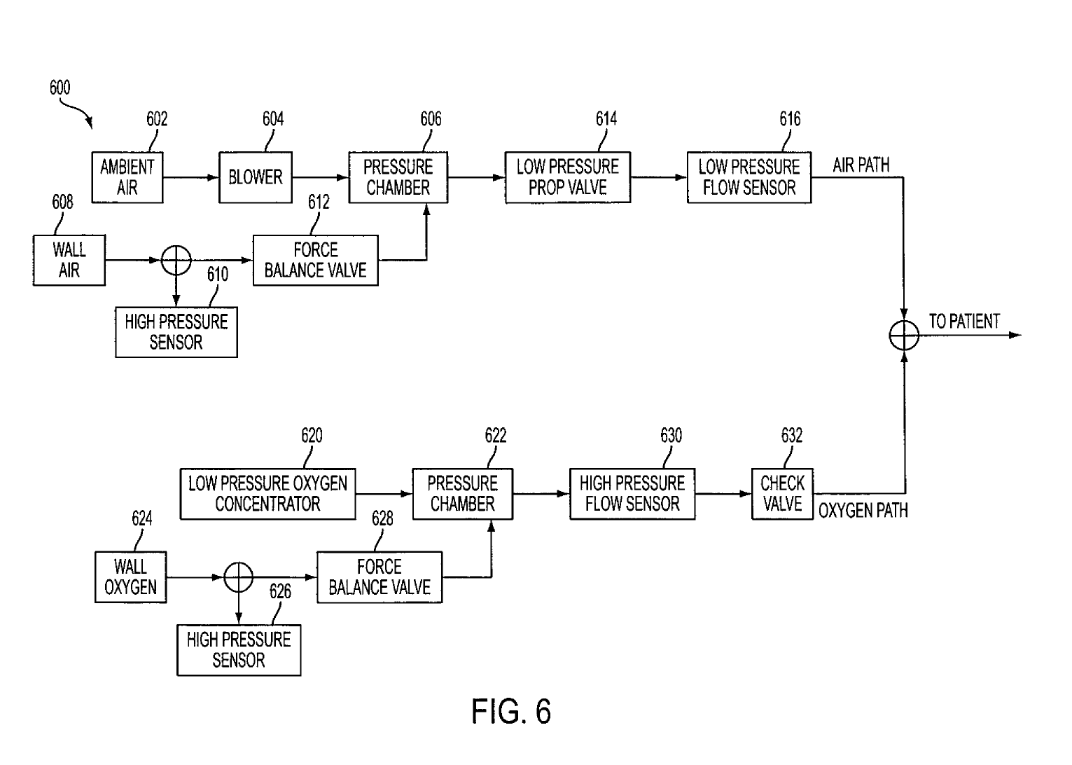

FIG. 6 provides an example configuration demonstrating how some embodiments provide a dual oxygen and air system configuration. A dual path system (oxygen and air) (600) may include an ambient air source (602) providing air or other gas to a blower (604). A wall air source (608) may provide air or gas through a force balanced vale (612) and into a low pressure chamber (606) after sufficient pressure reduction. Likewise, flow from blower (604) is directed into pressure chamber (606). A high pressure sensor (610) or similar detection device may be used to measure pressure, or to determine the loss of the high pressure source, e.g., wall air (608). Reduced pressure flow from the pressure chamber (606) is directed through a low pressure proportional valve (614) that may control flow rate, pressure, sigh ventilation or other flow characteristics. A low pressure sensor (616) may be used downstream prior to air path delivery to a patient.

A distinct flow channel is depicted in FIG. 6 where an oxygen path converges with an air path before delivery of gas to a patient. A low pressure oxygen concentrator (620) may provide gas to a pressure chamber (622). A wall oxygen source (624) may provide O₂ at high pressure, as detected by high pressure sensor (626) through a force balanced valve (628) that reduces pressure flow into the pressure chamber (622). A high pressure flow sensor (630) may detect down stream flow before gas is delivered through a check valve (632) into the oxygen path for delivery to a patient.

Although some embodiments presented herein are shown to include certain features, aspects of the invention specifically contemplate that any feature disclosed herein may be used together or in combination with any other feature on any embodiment of the invention. It is also contemplated that any feature may be specifically excluded from any embodiment of an invention. Although illustrative embodiments of the present invention have been described herein, it should be understood that the invention is not limited to those described, and that various other changes or modifications may be made by one skilled in the art without departing from the scope or spirit of the invention which is limited only by the claims appended hereto.

1. A breathing apparatus comprising:
(a) a low pressure gas source configured to deliver gas into a low pressure chamber;
(b) a high pressure gas inlet port connected to a force balance valve configured to deliver high pressure gas into the low pressure chamber after pressure reduction through the force balanced valve;
(c) a proportional valve assembly for receiving flow from both the high pressure gas inlet port and from the low pressure gas source;
(d) a control system that operates the proportional valve assembly; and
(e) an outlet port downstream of the proportional valve assembly.

2. The breathing apparatus of claim 1, wherein the low pressure source is selected from the set consisting of: a blower, liquid gas, compressor, a concentrator system and a piston.

3. The breathing apparatus of claim 1, further comprising a pressure detector configured to sense an absence of the high pressure gas, wherein the control system automatically engages the low pressure gas source in response to the pressure detector detecting the absence of the high pressure gas.

4. A breathing apparatus comprising:
(a) a low pressure gas inlet port configured to receive gas from a low pressure gas source;
(b) a high pressure gas inlet port configured to receive gas from a high pressure gas source;
(c) a means for reducing gas pressure downstream of the high pressure gas inlet port;
(d) a low pressure path configured to receive gas from both the means for reducing gas pressure and from the low pressure inlet port;
(e) a proportional low pressure valve coupled to the low pressure path and configured to control flow delivery to a patient.

5. The breathing apparatus of claim 4 further comprising an integrated control system capable of controlling the proportional low pressure valve and the activation of the low pressure gas source.

6. The breathing apparatus of claim 5 wherein the integrated control system controls and directs gas flow from at least one of the low pressure gas source and the high pressure gas source.

7. A method of providing breathable gas to a patient comprising:
(a) initiating high pressure gas flow from a high pressure gas source through a high pressure gas inlet port;
(b) reducing a pressure of the high pressure gas between the high pressure gas inlet port and a low pressure chamber or flow path;
(c) controlling a flow of the reduced high pressure gas from the low pressure chamber through a low pressure proportional control valve;
(d) detecting a reduction of pressure in the high pressure source;
(e) activating, in response to the detecting, a low pressure gas flow from a low pressure gas source through a low pressure gas inlet port;
(f) providing the low pressure gas flow from the gas inlet port into the low pressure chamber;
(g) controlling gas flow of the low pressure gas flow from the low pressure chamber through the low pressure proportional control valve; and
(h) providing gas flow to a patient downstream of the low pressure proportional control valve.

8. The method of claim 7 wherein gas flow is continuously provided to the patient.

9. The method of claim 7 wherein the providing the low pressure flow from the gas inlet port occurs for a set period of time.

10. The method of claim 9 that entails re-initiating the high pressure gas flow from the high pressure gas source after the set period of time has ended.

11. A method of providing breathable gas to a patient comprising:
(a) receiving data inputs related to the control of a breathing device;
(b) transferring data inputs into a control system;
(c) enabling the input of either a reduced high pressure gas flow path or a low pressure gas flow path into a low pressure valve based upon the data inputs to the control system;
(d) engaging the control system to control flow of either the reduced high pressure gas flow path or the low pressure gas flow path through the low pressure valve;
(e) detecting a presence or an absence of a high pressure gas source;
(f) creating a second set of data inputs based upon the presence or the absence of the high pressure gas source; and
(f) transferring the second set of data inputs to the control system.
